(19) United States
(12) Patent Application Publication
(10) Pub. No.: US 2011/0126193 A1
(43) Pub. Date: May 26, 2011

(54) System and Method for Imaging and Provisioning of Information Handling System

(75) Inventors: John Mullin, Edinburgh (GB); Amer Chowdhry, Colleyville, TX (US); Campbell McNeill, Edinburgh (GB); Christopher Speers, Austin, TX (US); Dana Ragsdill, Pflugerville, TX (US); Lawrence Smithmier, Pflugerville, TX (US)

(73) Assignee: DELL PRODUCTS, LP, Round Rock, TX (US)

(21) Appl. No.: 12/622,888

(22) Filed: Nov. 20, 2009

(51) Int. Cl. G06F 9/455

(52) U.S. Cl. 718/1; 713/2

(57) ABSTRACT

A method includes emulating an information handling system on a virtual machine, allowing users to create and validate an operating environment on the emulation, creating an image based on the validated environment, and loading the image onto an information handling system. The environment includes an operating system and an application from the virtual machine module, and an application from the user. A disk imaging system includes a virtual machine that emulates an information handling system, and a session manager that establishes a session between an interface and the virtual machine. The virtual machine allows users to create an operating environment including an operating system and an application from the virtual machine and an application from the users, and to validate the environment, captures an image of the environment, and loads the image onto an information handling system.

### FIELD OF THE DISCLOSURE

This disclosure relates generally to information handling systems, and relates more particularly to provisioning of information handling systems.

### BACKGROUND

As the value and use of information continues to increase, individuals and businesses seek additional ways to process and store information. One option is an information handling system. An information handling system generally-processes, compiles, stores, or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, data storage systems, and networking systems. An information handling system can be provisioned at the time of manufacture, assembly, or sale with a disk image in accordance with a customer's requirements.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are illustrated and described with respect to the drawings presented herein, in which:

FIG. 1 is an illustration of an information handling system manufacturing and delivery cycle, according to an embodiment of the present disclosure;

FIG. 2 is an illustration of a master disk image generation system, according to an embodiment of the present disclosure;

FIG. 3 is an illustration of a virtual session implemented on the master disk image generation system of FIG. 2;

FIG. 4 is a flowchart illustrating a method for imaging and provisioning information handling systems, according to an embodiment of the present disclosure; and

FIG. 5 is a functional block diagram illustrating an exemplary embodiment of an information handling system.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can be used in this application. The teachings can also be used in other applications, and with several different types of architectures, such as distributed computing architectures, client/server architectures, or middleware server architectures and associated resources.

For purposes of this disclosure, an information handling system can include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory (volatile such as random-access memory), nonvolatile such as read-only memory or flash memory) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as various input and output (I/O) devices such as a keyboard, a mouse, a video/graphic display, or any combination thereof. The information handling system can also include one or more buses operable to transmit communications between the various hardware components. Portions of an information handling system may themselves be considered information handling systems.

Portions of an information handling system, when referred to as a “device,” a “module,” or the like, can be configured as hardware, software (which can include firmware), or any combination thereof. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). Similarly, the device could be software, including firmware embedded at a device, such as a Pentium class or PowerPC™ brand processor, or other such device, or software capable of operating a relevant environment of the information handling system. The device could also be a combination of any of the foregoing examples of hardware or software. Note that an information handling system can include an integrated circuit or a board-level product having portions thereof that can also be any combination of hardware and software.

Devices or programs that are in communication with one another need not be in continuous communication with each other unless expressly specified otherwise. In addition, devices or programs that are in communication with one another may communicate directly or indirectly through one or more intermediaries.

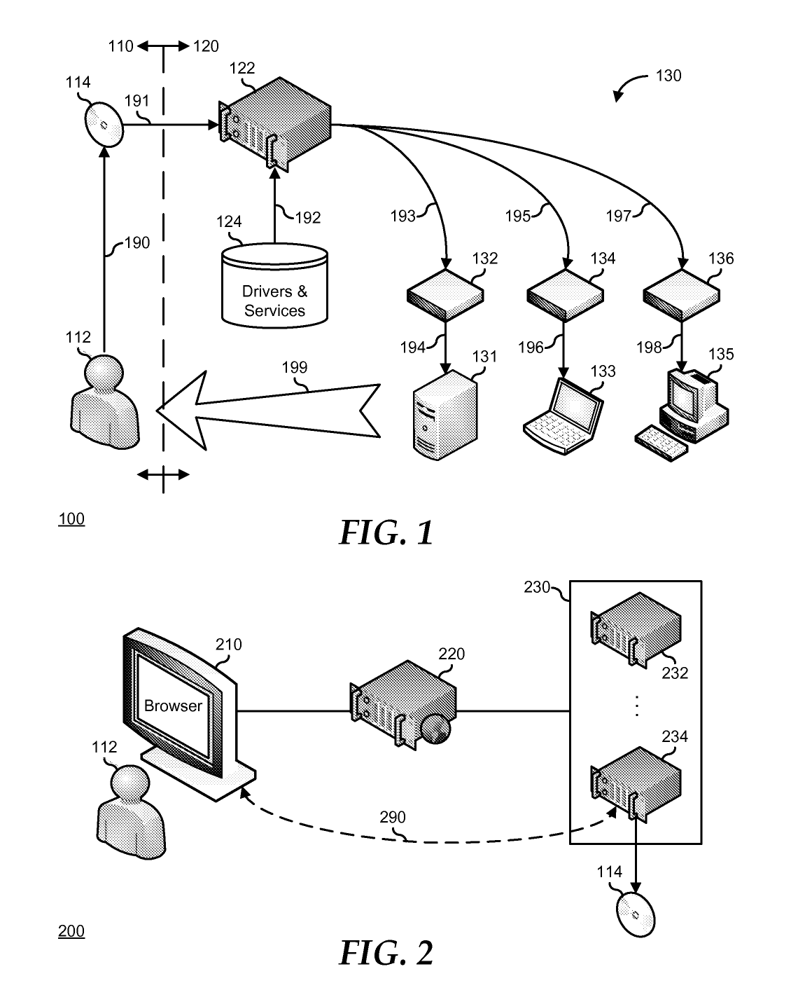

FIG. 1 illustrates an information handling system manufacturing and delivery cycle 100 that includes interactions between a customer side 110 and a manufacturer side 120. Customer side 110 includes a customer 112 and a master disk image 114. Manufacturing side 120 includes an order processing system 122, an information handling system drivers and services repository 124, and an assembly line 130. Assembly line 130 includes the ability to assemble various types of information handling systems, including a server system 131, a laptop system 133, and a desktop system 135. Server system 131 includes a server disk image 132, laptop system 133 includes a laptop disk image 134, and desktop system 135 includes a desktop disk image 136.

On customer side 110, customer 112 determines that a need exists to obtain one or more information handling systems. Customer 112 can include an individual, group of individuals, or an organization. The need for information handling systems can be based upon the personal need of customer 112, a need to provide an office computing infrastructure, a need for server capacity or other data processing capabilities, another need for computing resources, or a combination thereof. The need for information handling systems can be defined in terms of a list of various types of information handling systems and a number of each type. For example, an office manager desiring to equip a new office may need one network storage server, fifteen laptop computers, and eight desktop computers. The need for information handling systems can also be defined in terms of an operating environment needed on each information handling system. For example, the above office manager may wish to have all of the laptop and desktop computers loaded with a common operating system and suite of applications.

In a particular embodiment (not illustrated), customer 112 orders the various information handling systems in a blank state from a manufacturer, and installs the desired operating system and suite of applications to create the desired operating environment. In another embodiment (not illustrated), customer 112 orders the various information handling systems with the desired operating system and a common suite of applications pre-installed, and modifies the operating environment by adding the desired suite of applications. In these embodiments, customer 112 ensures that the installation of the desired operating system and suite of applications is customized to the particular type of information handling system. For example, the features and capabilities of the desired operating system can vary depending on whether the information handling system is a laptop computer or a desktop computer. Such features can include power management and battery optimization features available in a laptop computer, but not in a desktop computer, add-in card drivers for devices found in one type, but not in another, other features, or a combination thereof.

In the illustrated embodiment, customer 112 received information handling systems from manufacturing side 120 with the desired operating system and suite of applications already customized to the particular type of information handling system. Here, customer 112 creates master disk image 114 as shown by arrow 190. Master disk image 114 includes information used in manufacturing side 120 to customize information handling systems provided to customer side 110 with the desired operating system and suite of applications. Thus, for example, master disk image 114 can include a list of desired features, or can be computer readable file information that includes a data image of the desired features. Order processing system 122 receives master disk image 114 as shown by arrow 191, and adapts the information contained therein, to customize the various information handling systems. Order processing system 122 also receives information from drivers and services repository 124 as shown by arrow 192. Drivers and services repository 124 includes information related to the specific functionality and capabilities of server system 131, laptop system 133, and desktop system 135. For example, drivers and services repository 124 can include device drivers for the specific devices found in server system 131, laptop system 133, and desktop system 135. In a particular embodiment, drivers and services repository 124 is maintained with current device drivers and hardware and software service packs, so that as production of server system 131, laptop system 133, and desktop system 135 is performed, each of systems 131, 133, and 135 are provided to customer 112 with the current software revisions. In another embodiment, customer side 110 can provide master disk image 114 with the most current software revisions.

Order processing system 122 combines the information from master disk image 114 and from drivers and services repository 124 to create server disk image 132 as shown by arrow 193, laptop disk image 134 as shown by arrow 195, and desktop disk image 136 as shown by arrow 197. Server disk image 132 is installed into server system 131 as shown by arrow 194. In a particular embodiment, server disk image 132 is loaded on a disk drive that is then installed into server system 131. In another embodiment, server system 131 is assembled with a disk drive that is then loaded with server disk image 132. Similarly, laptop disk image 134 is installed into laptop system 133 as shown by arrow 196, and desktop disk image 136 is installed into desktop system 135 as shown by arrow 198. The assembled server system 131, laptop system 133, and desktop system 135 are assembled are then shipped to customer side 110 as shown by arrow 199. In this way, server system 131, laptop system 133, and desktop system 135 arrive at customer side 110 pre-configured with the desired operating system and suite of applications, and additional configuration may not be necessary prior to use by customer 112. In a particular embodiment, the pre-configuration is implemented such that the features and functionality of master disk image 114 are available the first time that server system 131, laptop system 133, and desktop system 135 are powered on at customer side 110. In another embodiment, server disk image 132, laptop disk image 134, and desktop disk image 136 are implemented as cabinet files (CAB files), such that an old image is installed the first time the respective server system 131, laptop system 133, and desktop system 135 is powered on.

FIG. 2 illustrates a master disk image generation system 200 that includes an interface module 210, a session management module 220, and a virtual machine module 230. Virtual machine module 230 includes a virtual machine 232 and one or more additional virtual machines 234. Interface module 210 is connected to session management module 220, and session management module 220 is connected to virtual machine module 230. Master disk image generation system 200 permits customer 112 to interactively configure and generate master disk image 114. Interface module 210, session management module 220 and virtual machine module 230 can each be a separate system such as an information handling system, or the functionality thereof can be combined together into one or more systems, as described below. Thus, in a particular embodiment, master disk image generation system 200 is a web-based system wherein interface module 210 is an information handling system that includes a web browsing application and that is associated with customer 112, and session management module 220 is a web server that can include the functionality of virtual machine module 230, or that can include a web-based or proprietary link to virtual machine module 230. In another embodiment, master disk image generation system 200 is a service system provided by manufacturing side 120, and where interface module 210, session management module 220, and virtual machine module 230 are associated with manufacturing side 120.

In operation, customer 112 initiates a session on session management module 220 via interface module 210. Session management module 220 provides a user interface (not illustrated) on interface module 210 whereby customer 112 can create, delete, or edit master disk image 114. As such, session management module 220 can include storage (not illustrated) that includes previously created master disk images, manufacturer stock master disk images, or libraries of selectable applications, macros, set-up files, custom commands, or other information used to create or edit master disk image 114. When customer 112 desires to create, delete, or edit master disk image 114, session management module 220 sends a virtual machine ticket to virtual machine module 230. The virtual machine ticket acts to request the services of one of virtual machines 232 or 234 for creating, deleting, or modifying master disk image 114. When virtual machine module 230 determines that resources are available, in the form of one of virtual machines 232 or 234, then the available resource is allocated to the use of customer 112. In another embodiment, when virtual machine module 230 receives the ticket, then virtual machine module 230 launches a new virtual machine 232 or 234 that is made available to customer 112.

In the illustrated example, virtual machine 234 is available to customer 112. In a particular embodiment, when virtual machine 234 is available to customer 112, session management module 220 establishes a virtual session 290 between interface module 210 and virtual machine 234, and session management module 220 launches a web application (not illustrated) on interface module 210 that permits client 112 to interact directly with virtual machine 234 to create master disk image 114. In a particular embodiment, session management module 220 and virtual machine module 230 are provided as a service to customer 112 by manufacturing side 120, and the creation of master disk image 114 is integrated seamlessly into the functions of manufacturing side 120, as described above.

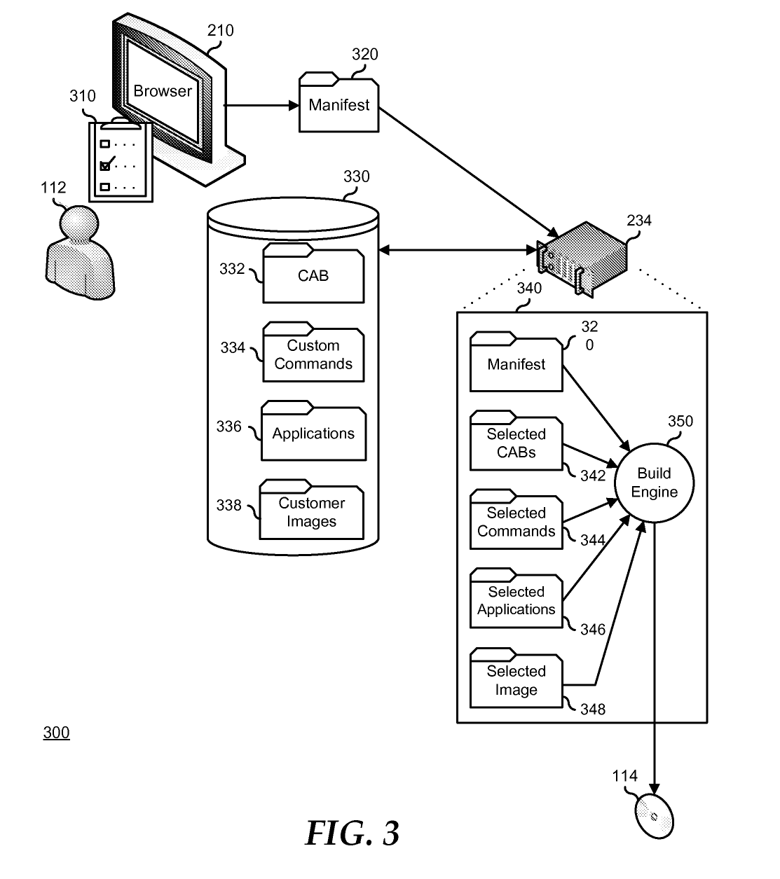

FIG. 3 illustrates a virtual session 300, similar to virtual session 290, between interface module 210 and virtual machine 234. Here, customer 112 interacts with a user interface 210 on interface module 210. User interface 310 provides image management options to customer 112, such that customer 112 can create new images, or edit or delete existing images. User interface 310 also provides editing options for new or existing images. The editing options represent the contents of a content storage 330 that are selectable for implementation in master disk image 114. Content storage 330 includes a selection of CAB files 332, a selection of custom commands 334, a selection of applications 336, and a selection of customer images 338. For example, CAB files 332 can include compressed installation files for creating virtualization environments on the target information handling system and for installing operating systems, custom commands 334 can include macros, set-up files, utilities, or other files for inclusion on the target information handling system, applications 336 can include office productivity applications, database management software, custom applications, or other applications, and customer images 338 can include previously created image files. Some or all of the contents of CAB files 332, custom commands 334, applications 336 and customer images 338 can be included in master disk image 114, according to the selections made by customer 112 in user interface 310. When customer 112 is finished selecting options for master disk image 114 on interface module 210, user interface 310 creates a manifest 320 that includes the selected options.

In a particular embodiment, content storage 330 is included in virtual machine module 230. Here, manifest 320 is sent to virtual machine 234, and virtual machine 234 determines the selected options from manifest 320 and retrieves the selected CAB files 342, selected commands 344, selected applications 346 and selected images 348 from content storage 330. Virtual machine 234 launches a virtual drone 340 that emulates an information handling system, and loads virtual drone 340 with manifest 320, selected CAB files 342, selected commands 344, selected applications 346, and selected images 348. Customer 112 then interacts with virtual drone 340 to determine if the selected options function correctly, and to validate the disk image created thereon. If the operation of virtual drone 340 is satisfactory to customer 112, then customer 112 directs a build engine 350 to capture the disk image of virtual drone 340 and to create master disk image 114. Master disk image 114 is then sent to manufacturing side 120, or stored on content storage 330. If the operation of virtual drone is unsatisfactory to customer 112, then customer 112 modifies the selected options in manifest 320 and virtual machine 234 modifies virtual drone accordingly.

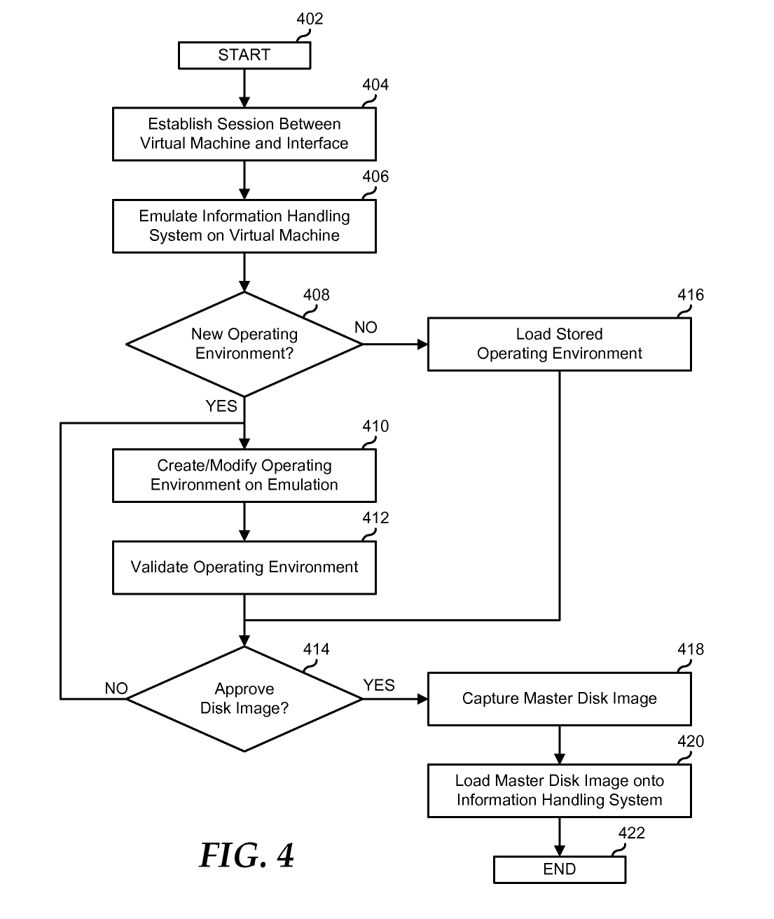

FIG. 4 illustrates a method for imaging and provisioning information handling systems in a flowchart form, in accordance with an embodiment of the present disclosure. The method starts at block 302. A session is established between a virtual machine and a user interface in block 404. For example, session management module 220 can establish virtual session 290 between interface module 210 and virtual machine module 230. An information handling system is emulated on the virtual machine in block 406. Thus, virtual machine 234 can launch virtual drone 340 as an emulation of server system 131, laptop system 133, or desktop system 135. A decision is made as to whether or not a new environment is to be created on the emulated information handling system in decision block 408. If so, the “YES” branch of decision block 408 is taken, and an operating environment is created to run on the emulated information handling system in block 410. For example, a particular CAB file for a selected operating system can be loaded from CAB files 332 to virtual drone 340. Further, particular applications and custom commands can be loaded from custom commands 334 and applications 336 into virtual drone 340. The operating environment is validated to determine if the disk image thereof provides satisfactory functionality in block 412.

If a new environment is not to be created on the emulated information handling system, as determined in decision block 408, then the “NO” branch of decision block 408 is taken, and a stored operating environment is loaded onto the emulated information handling system in block 416. For example, a customer image can be loaded from customer images 338 onto virtual drone 340. After the operating environment is either loaded in block 416, or validated in block 412, a decision is made as to whether or not the disk image is approved in block 414. If not, the “NO” branch of decision block 414 is taken and processing returns to block 410 where the operating environment is modified on the emulated information handling system. If the disk image is approved, the “YES” branch of decision block 414 is taken and a master disk image is captured in block 418. Thus, build engine 350 can create master disk image 114. The master disk image is loaded onto a physical information handling system in block 420. Here, master disk image 114 can be provided to order processing system 122 for distribution to server disk image 132, laptop disk image 134, and desktop disk image 136. Processing ends in block 422.

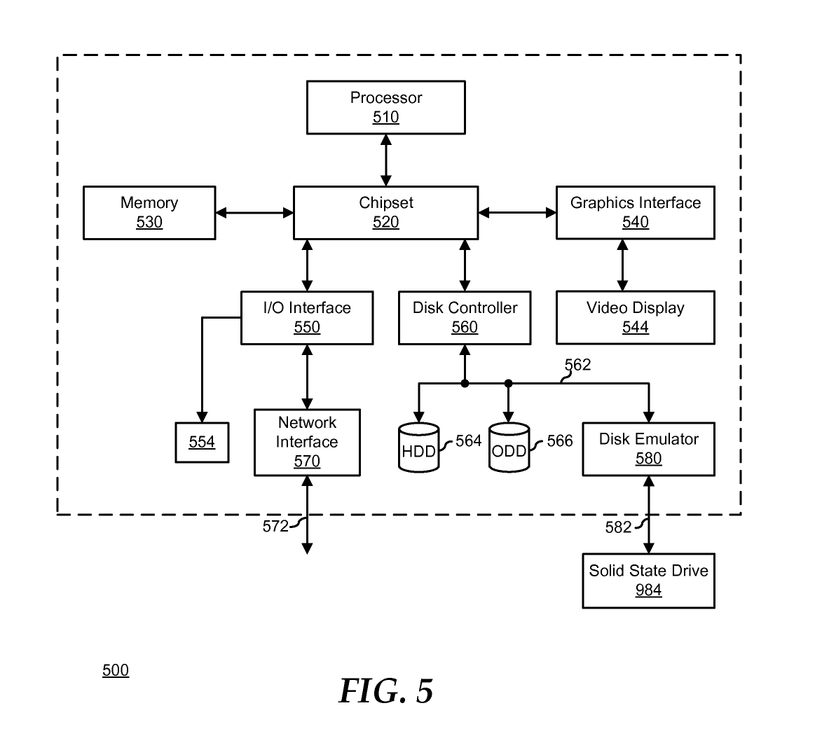

In a particular embodiment, an information handling system can be used to function as one or more of the network systems, or carry out one or more of the methods described above. In another embodiment, one or more of the systems described above can be implemented in the form of an information handling system. FIG. 5 illustrates a functional block diagram of an embodiment of an information handling system, generally designated as 500. Information handling system 500 includes processor 510, a chipset 520, a memory 530, a graphics interface 540, an input/output (I/O) interface 550, a disk controller 560, a network interface 570, and a disk emulator 580.

Processor 510 is coupled to chipset 520. Chipset 520 supports processor 510, allowing processor 510 to process machine-executable code. In a particular embodiment (not illustrated), information handling system 500 includes one or more additional processors, and chipset 520 supports the multiple processors, allowing for simultaneous processing by each of the processors, permitting the exchange of information between the processors and the other elements of information handling system 500. Processor 510 can be coupled to chipset 520 via a unique channel, or via a bus that shares information between processor 510, chipset 520, and other elements of information handling system 500.

Memory 530 is coupled to chipset 520. Memory 530 can be coupled to chipset 520 via a unique channel, or via a bus that shares information between chipset 520, memory 530, and other elements of information handling system 500. In particular, a bus can share information between processor 510, chipset 520 and memory 530. In a particular embodiment (not illustrated), processor 510 is coupled to memory 530 through a unique channel. In accordance with another aspect (not illustrated), an information handling system can include a separate memory dedicated to each of the processors. A non-limiting example of memory 530 includes static, dynamic. Or non-volatile random access memory (SRAM, DRAM, or NVRAM), read only memory (ROM), flash memory, another type of memory, or any combination thereof.

Graphics interface 540 is coupled to chipset 520. Graphics interface 540 can be coupled to chipset 520 via a unique channel, or via a bus that shares information between chipset 520, graphics interface 540, and other elements of information handling system 500. Graphics interface 540 is coupled to a video display 544. Other graphics interfaces (not illustrated) can also be used in addition to graphics interface 540 if needed or desired. Video display 544 can include one or more types of video displays, such as a flat panel display or other type of display device.

I/O interface 550 is coupled to chipset 520. I/O interface 550 can be coupled to chipset 520 via a unique channel, or via a bus that shares information between chipset 520, I/O interface 550, and other elements of information handling system 500. Other I/O interfaces (not illustrated) can also be used in addition to I/O interface 550 if needed or desired. I/O interface 550 is coupled to one or more add-on resources 554. Add-on resource 554 can also include another data storage system, a graphics interface, a network interface card (NIC), a sound/video processing card, another suitable add-on resource or any combination thereof.

Network interface device 570 is coupled to I/O interface 550. Network interface 570 can be coupled to I/O interface 550 via a unique channel, or via a bus that shares information between I/O interface 550, network interface 570, and other elements of information handling system 500. Other network interfaces (not illustrated) can also be used in addition to network interface 570 if needed or desired. Network interface 570 can be a network interface card (NIC) disposed within information handling system 500, on a main circuit board (e.g., a baseboard, a motherboard, or any combination thereof), integrated onto another component such as chipset 520, in another suitable location, or any combination thereof. Network interface 570 includes a network channel 572 that provide interfaces between information handling system 500 and other devices (not illustrated) that are external to information handling system 500. Network interface 570 can also include additional network channels (not illustrated).

Disk controller 560 is coupled to chipset 510. Disk controller 560 can be coupled to chipset 520 via a unique channel, or via a bus that shares information between chipset 520, disk controller 560, and other elements of information handling system 500. Other disk controllers (not illustrated) can also be used in addition to disk controller 560 if needed or desired. Disk controller 560 can include a disk interface 562. Disk controller 560 can be coupled to one or more disk drives via disk interface 562. Such disk drives include a hard disk drive (HDD) 564 or an optical disk drive (ODD) 566 (e.g., a Read/Write Compact Disk (R/W-CD), a Read/Write Digital Video Disk (R/W-DVD), a Read/Write mini Digital Video Disk (R/W mini-DVD), or another type of optical disk drive), or any combination thereof. Additionally, disk controller 560 can be coupled to disk emulator 580. Disk emulator 580 can permit a solid-state drive 584 to be coupled to information handling system 500 via an external interface. The external interface can include industry standard busses (e.g., USB or IEEE 1384 (Firewire)) or proprietary busses, or any combination thereof. Alternatively, solid-state drive 584 can be disposed within information handling system 500.

In the embodiments described above, an information handling system can include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described above can be configured as hardware, software (which can include firmware), or any combination thereof. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). Similarly, the device could be software, including firmware embedded at a device, such as a Pentium class or PowerPC™ brand processor, or other such device, or software capable of operating a relevant environment of the information handling system. The device could also be a combination of any of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method comprising:
emulating an information handling system on a virtual machine module;
allowing an end user to create an operating environment on the emulated information handling system, wherein the operating environment comprises:
an operating system and a standard application offered by the virtual machine module; and
a custom application provided by the end user;
allowing the end user to validate the operating environment on the emulated information handling system;
in response to validating the operating environment, creating a disk image based on the operating environment; and
automatically loading the disk image onto a physical information handling system.

2. The method of claim 1, wherein in creating the operating environment, the method further comprises receiving first information from a web browser, the first information operable to identify the operating system from among a plurality of operating systems.

3. The method of claim 2, wherein in creating the operating environment, the method further comprises receiving second information from the web browser, the second information operable to identify the standard application from among a plurality of standard applications.

4. The method of claim 3, wherein in creating the operating environment, the method further comprises receiving the custom application from the web browser

5. The method of claim 1, wherein the disk image comprises a copy of an emulated disk that includes the operating environment of the emulated first information handling system.

6. The method of claim 1, wherein the disk image comprises a compressed cabinet file which, when decompressed on the second information handling system, includes a copy of an emulated disk that includes the operating environment of the emulated first information handling system.

7. The method of claim 1, wherein in automatically loading the disk image, the method further comprises modifying the disk image to include updated drivers for the second information handling system.

8. A disk imaging system comprising:
a virtual machine module operable to emulate an information handling system; and
a session management module coupled to the virtual machine module and operable to establish a session between an interface module and the virtual machine module;
wherein the virtual machine module is operable to:
receive information from the interface module, the information operable to allow an end user to create an operating environment on the emulated information handling system, the operating environment including:
an operating system and a standard application offered by the virtual machine module; and
a custom application provided by the end user;
allow the end user to validate the operating environment on the emulated information handling system;
in response to validating the operating environment, capture a disk image of the operating environment; and
load the disk image onto a physical information handling system, wherein the emulated information handling system is an emulation of the physical information handling system.

9. The disk imaging system of claim 8, wherein the information includes a selection of the operating system from among a plurality of operating systems.

10. The disk imaging system of claim 9, wherein the information includes a selection of the standard application from among a plurality of standard applications.

11. The disk imaging system of claim 8, wherein the disk image comprises a copy of an emulated disk that includes the operating environment of the emulated information handling system.

12. The disk imaging system of claim 8, wherein the disk image comprises a compressed cabinet file which, when decompressed on the physical information handling system, includes a copy of an emulated disk that includes the operating environment of the emulated information handling system.

13. The disk imaging system of claim 8, wherein the session is an Internet based session, and the interface module comprises a web browser.

14. The disk imaging system of claim 8, wherein in loading the disk image, the virtual machined module is further operable to modify the disk image to include updated drivers for the physical information handling system.

15. Machine-executable code for an information handling system comprising a first resource, wherein the machine-executable code is embedded within a tangible medium and includes instructions for carrying out a method comprising:
emulating an information handling system on a virtual machine module;
allowing an end user to create an operating environment on the emulated information handling system, wherein the operating environment comprises:
an operating system and a standard application offered by the virtual machine module; and
a custom application provided by the end user;
allowing the end user to validate the operating environment on the emulated information handling system;
in response to validating the operating environment, creating a disk image based on the operating environment; and
automatically loading the disk image onto a physical information handling system.

16. The machine-executable code of claim 15, wherein in creating the operating environment, the method further comprises receiving first information from a web browser, the first information operable to identify the operating system from among a plurality of operating systems.

17. The machine-executable code of claim 16, wherein in creating the operating environment, the method further comprises receiving second information from the web browser, the second information operable to identify the standard application from among a plurality of standard applications.

18. The machine-executable code of claim 15, wherein the disk image comprises a copy of an emulated disk that includes the operating environment of the emulated information handling system.

19. The machine-executable code of claim 15, wherein the disk image comprises a compressed cabinet file which, when decompressed on the physical information handling system, includes a copy of an emulated disk that includes the operating environment of the emulated information handling system.

20. The machine-executable code of claim 15, wherein in automatically loading the disk image, the method further comprises modifying the disk image to include updated drivers for the physical information handling system.
